(19) United States
(12) Patent Application Publication
(10) Pub. No.: US 2018/0129085 A1
(43) Pub. Date: May 10, 2018

(54) LAMINATED FILM AND METHOD FOR MANUFACTURING LAMINATED FILM

(71) Applicant: FUJIFILM Corporation, Tokyo (JP)

(72) Inventors: Satoshi KUNIYASU, Kanagawa (JP); Tatsuya OBA, Kanagawa (JP)

(73) Assignee: FUJIFILM Corporation, Tokyo (JP)

(21) Appl. No.: 15/864,200

(22) Filed: Jan. 8, 2018

Related U.S. Application Data
(63) Continuation of application No. PCT/JP2016/070127, filed on Jul. 7, 2016.

(30) Foreign Application Priority Data
Jul. 10, 2015 (JP) 2015-138720
Oct. 29, 2015 (JP) 2015-212556

(51) Int. Cl. G02F 1/1335

(52) U.S. Cl. CPC G02F 1/1336; B05D 1/28

(57) ABSTRACT

Provided are a highly flat laminated film having an optically functional layer such as a quantum dot layer, in which a member such as a quantum dot performing an optical function can be prevented from deteriorating due to the permeation of oxygen or the like from an end face, and a method for manufacturing a laminated film. The laminated film includes a functional layer laminate having an optically functional layer and a gas barrier layer laminated on at least one main surface of the optically functional layer and an end face sealing layer formed by covering at least a portion of the end face of the functional layer laminate, and the end face sealing layer has an oxygen permeability of equal to or lower than 10 cc/(m²·day·atm).

### CROSS-REFERENCE TO RELATED APPLICATIONS

This application is a Continuation of PCT International Application No. PCT/JP2016/070127 filed on Jul. 7, 2016, which claims priority under 35 U.S.C. § 119(a) to Japanese Patent Application No. 2015-138720 filed on Jul. 10, 2015 and Japanese Patent Application No. 2015-212556 filed on Oct. 29, 2015. Each of the above applications is hereby expressly incorporated by reference, in its entirety, into the present application.

### BACKGROUND OF THE INVENTION

### 1. Field of the Invention

The present invention relates to a laminated film used in a backlight or the like of a liquid crystal display and a method for manufacturing a laminated film.

### 2. Description of the Related Art

As an image display device that consumes less power and occupies a small space, a liquid crystal display (hereinafter, referred to as LCD as well) is increasingly widely used year after year. Furthermore, in recent years, for the liquid crystal display, a further reduction in power consumption, the enhancement of color reproducibility, and the like have been required as the improvement of LCD performance.

As the reduction in power consumption is required for LCD, in order to increase light use efficiency and enhance color reproducibility in a backlight (backlight unit), the use of a quantum dot which emits light by converting the wavelength of incidence rays in the backlight is suggested.

The quantum dot is in an electronic state of which the movement is restricted in all directions in a three-dimensional space. In a case where a semiconductor nanoparticle is three-dimensionally surrounded by a high-potential barrier, the nanoparticle becomes a quantum dot. The quantum dot exhibits various quantum effects. For example, the quantum dot exhibits “quantum size effect” in which the state density (energy level) of an electron becomes discrete. According to the quantum size effect, by changing the size of the quantum dot, the absorption wavelength-emission wavelength of light can be controlled.

Generally, by being dispersed in a matrix formed of a resin such as an acrylic resin or an epoxy resin, quantum dots are made into a quantum dot layer. For example, the quantum dot layer is used as a quantum dot film for wavelength conversion by being disposed between a backlight and a liquid crystal panel.

In a case where excitation light from a backlight is incident on the quantum dot film, the quantum dots are excited and emit fluorescence. At this time, in a case where quantum dots having different emission characteristics are used, light having a narrow half-width such as red light, green light, and blue light are emitted, and hence white light can be realized. Because the fluorescence from the quantum dots has a narrow half-width, by appropriately selecting the wavelength, it is possible to obtain white light with high luminance or to prepare a design so as to obtain excellent color reproducibility.

Incidentally, unfortunately, the quantum dots easily deteriorate due to oxygen or the like, and the emission intensity of the quantum dots deteriorates due to a photo-oxidation reaction. Therefore, in a quantum dot film, by laminating a gas barrier film on both surfaces of a quantum dot layer, the quantum dot layer is protected.

However, in a case where both surfaces of the quantum dot layer are simply sandwiched between gas barrier films, unfortunately, moisture or oxygen permeates the quantum dot layer from the end face not being covered with the gas barrier film, and hence the quantum dots deteriorate.

Accordingly, a method is suggested in which in addition to the both surfaces of a quantum dot layer, the periphery of the quantum dot layer is also sealed with a gas barrier film or the like.

For example, WO2012/102107A describes a composition obtained by dispersing quantum dot phosphors in a cycloolefin (co)polymer at a concentration within a range of 0.0% to 20% by mass, and describes a constitution including a gas barrier layer that coats the entire surface of a resin-molded material in which quantum dots are dispersed. WO2012/102107A also describes that the gas barrier layer is a gas barrier film forming a silica film or an alumina film on at least one surface of the resin layer.

JP2013-544018A describes a display backlight unit including a remote phosphor film containing an emission quantum dot (QD) aggregate, and describes a constitution in which a QD phosphor material is sandwiched between two gas barrier films, and an inert region having gas barrier properties is located in a region sandwiched between the two gas barrier films at the periphery around the QD phosphor material.

JP2009-283441A describes a light emitting device including a color conversion layer that converts at least a portion of colored light emitted from a light source portion into another colored light and an impermeable sealing sheet that seals the color conversion layer, and describes a constitution including a second adhesive layer provided in the form of a frame along the outer periphery of a phosphor layer that becomes the color conversion layer, that is, surrounding the planar shape of the phosphor layer, in which the second adhesive layer formed of an adhesive material having gas barrier properties.

Furthermore, JP2010-61098A describes a quantum dot wavelength converter having a quantum dot layer (wavelength converting portion) and sealing members formed of silicone or the like that seals the quantum dot layer, and describes a constitution in which the quantum dot layer is sandwiched between the sealing members, and the sealing members are bonded to each other on the periphery of the quantum dot layer.

### SUMMARY OF THE INVENTION

Incidentally, a laminated film containing quantum dots that is used for LCD is a thin film having a thickness of about 50 μm to 350 μm.

Coating the entire surface of the thin quantum dot layer with a gas barrier film as in WO2012/102107A is extremely difficult, and doing such a thing has a problem of poor productivity. In addition, in a case where the gas barrier film is folded, the barrier layer cracks, and this leads to a problem of the deterioration of gas barrier properties.

In a case where a constitution is adopted in which a protective layer having gas barrier properties is formed in an end face region of a quantum dot layer sandwiched between two gas barrier films as described in JP2013-544018A and JP2009-283441A, a so-called dam filling-type laminated film is prepared by forming a protective layer at the peripheral portion of one gas barrier film, then forming a resin layer in the region surrounded by the protective layer, and then laminating the other gas barrier film on the protective layer and the resin layer. In this case, because the entire process is performed by a batch method, the problem of extremely poor productivity arises. Furthermore, because the width of the protective layer increases, the quantum dot layer is not formed on the edge. Accordingly, the area of an effectively usable region decreases, and this leads to the problem of the enlargement of a frame portion.

In the constitution described in JP2010-61098A in which the opening on the edge of two gas barrier films sandwiching the quantum dot layer therebetween is narrowed and sealed, the thickness of the quantum dot layer on the edge decreases. Accordingly, the area of an effectively usable region decreases, and this leads to the problem of the enlargement of a frame portion. In addition, because a barrier layer having high gas barrier properties is generally hard and brittle, in a case where a gas barrier film having such a barrier layer is suddenly curved, unfortunately, the barrier layer cracks, and the gas barrier properties deteriorate.

The present invention is for solving the aforementioned problems of the related art, and objects thereof are to provide a highly flat laminated film having an optically functional layer such as the quantum dot layer, in which a member such as a quantum dot performing an optical function can be prevented from deteriorating due to the permeation of oxygen or the like from an end face, and to provide a method for manufacturing a laminated film.

In order to achieve the aforementioned objects, the inventors of the present invention conducted an intensive study. As a result, the inventors obtained knowledge that the objects can be achieved by adopting a constitution including a functional layer laminate, having an optically functional layer and a gas barrier layer laminated on at least one main surface of the optically functional layer, and an end face sealing layer formed by covering at least a portion of the gas barrier layer and the optically functional layer of an end face of the functional layer laminate, in which the end face sealing layer has an oxygen permeability of equal to or lower than 10 cc/(m²·day·atm). Based on the knowledge, the inventors have accomplished the present invention.

That is, the present invention provides a laminated film having the following constitution and a manufacturing method of the laminated film.

(1) A laminated film comprising a functional layer laminate having an optically functional layer and a gas barrier layer laminated on at least one main surface of the optically functional layer, and an end face sealing layer formed by covering at least a portion of the gas barrier layer and the optically functional layer of an end face of the functional layer laminate, in which the end face sealing layer has an oxygen permeability of equal to or lower than 10 cc/(m²·day·atm).

(2) The laminated film described in (1), in which the end face scaling layer has a laminated structure in which two or more layers are laminated.

(3) The laminated film described in (1) or (2), in which a thickness of the end face sealing layer in a direction perpendicular to the end face of the functional layer laminate is equal to or smaller than ½ of a thickness of the functional layer laminate in a direction perpendicular to a main surface of the functional layer laminate.

(4) The laminated film described in any one of (1) to (3), in which the end face sealing layer covers the entirety of the end face of the functional layer laminate.

(5) The laminated film described in any one of (1) to (4), in which the end face sealing layer is a resin layer formed of a composition and having an oxygen permeability of equal to or lower than 10 cc/(m²·day·atm), and provided that a total amount of solid contents in the composition is 100 parts by mass, the composition contains either a resin composition selected from the group consisting of a polyvinyl alcohol-based resin, a polyvinylidene chloride resin, polyacrylonitrile, a polyvinylidene fluoride resin, and polyoxymethylene or a polymerizable compound having at least one polymerizable functional group selected from a (meth)acryloyl group, a vinyl group, a glycidyl group, an oxetane group, and an alicyclic epoxy group in an amount of equal to or less than 5 parts by mass.

(6) The laminated film described in any one of (1) to (5), in which in a cross-section perpendicular to an extension direction of the end face of the functional layer laminate, the end face sealing layer has a shape formed of a portion of a circle.

(7) A method for manufacturing a laminated film, comprising a preparation step of preparing a functional layer laminate having an optically functional layer and a gas barrier layer laminated on at least one main surface of the optically functional layer, and a sealing layer forming step of forming an end face sealing layer having an oxygen permeability of equal to or lower than 10 cc/(m²·day·atm) on an end face of the functional layer laminate, in which in the sealing layer forming step, the end face sealing layer is formed by bringing the end face of the functional layer laminate into contact with a coating film of a composition that becomes the end face sealing layer.

(8) The method for manufacturing a laminated film described in (7), in which in the sealing layer forming step, the end face sealing layer is formed by forming the coating film of the composition on a flat plate and bringing the end face of the functional layer laminate into contact with the coating film on the flat plate.

(9) The method for manufacturing a laminated film described in (7), in which in the sealing layer forming step, the end face sealing layer is formed by forming the coating film of the composition on a rotating roll and bringing the end face of the functional layer laminate into contact with the coating film on the roll.

According to the present invention, it is possible to provide a highly flat laminated film having an optically functional layer such as a quantum dot layer, in which a functional member such as a quantum dot performing an optical function can be prevented from deteriorating due to oxygen or the like permeating from an end face of the functional layer laminate by an end face sealing layer sealing the end face, and to provide a method for manufacturing a laminated film.

### BRIEF DESCRIPTION OF THE DRAWINGS

FIG. 1 is a cross-sectional view schematically showing an example of a laminated film of the present invention.

FIG. 2 is a cross-sectional view schematically showing an example of a gas barrier layer used in the laminated film of the present invention.

FIG. 3A is a schematic view for illustrating the relationship between the thickness of a functional layer laminate and the thickness of an end face sealing layer.

FIG. 3B is a schematic view for illustrating the relationship between the thickness of the functional layer laminate and the thickness of the end face sealing layer.

FIG. 4A is a schematic view for illustrating a method for manufacturing a laminated film of the present invention.

FIG. 4B is a schematic view for illustrating the method for manufacturing a laminated film of the present invention.

FIG. 4C is a schematic view for illustrating the method for manufacturing a laminated film of the present invention.

FIG. 5A is a schematic view for illustrating another example of the method for manufacturing a laminated film of the present invention.

FIG. 5B is a schematic view for illustrating another example of the laminated film of the present invention.

FIG. 6 is a schematic view for illustrating another example of the method for manufacturing a laminated film of the present invention.

FIG. 7A is an enlarged picture of a portion of the end face sealing layer of the laminated film prepared in an example.

FIG. 7B is an enlarged picture of a portion of the end face sealing layer of the laminated film prepared in the example.

### DESCRIPTION OF THE PREFERRED EMBODIMENTS

Hereinafter, the laminated film and the method for manufacturing a laminated film of the present invention will be specifically described based on suitable examples shown in the attached drawings.

The following components will be described based on typical embodiments of the present invention in some cases, but the present invention is not limited to the embodiments.

In the present specification, a range of numerical values described using “to” means a range including the numerical values listed before and after “to” as a lower limit and an upper limit respectively.

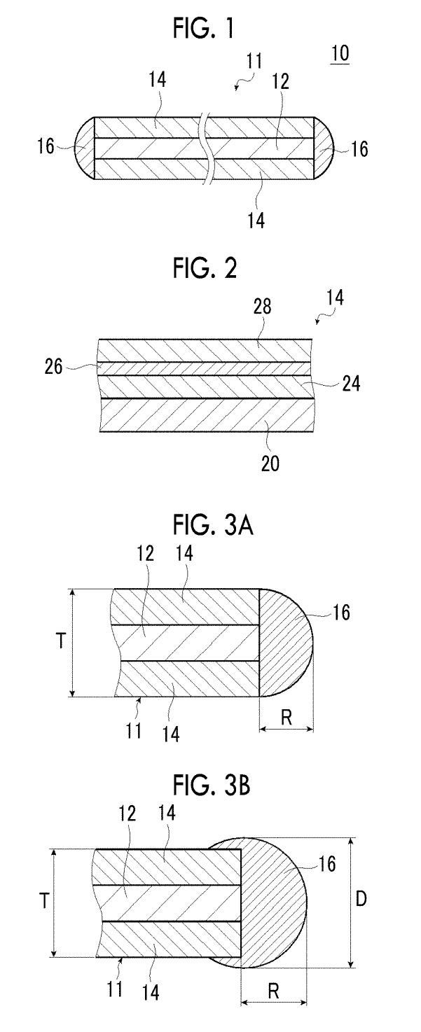

FIG. 1 is a cross-sectional view schematically showing an example of a laminated film of the present invention.

A laminated film 10 shown in FIG. 1 has an optically functional layer 12, gas barrier layers 14, and an end face sealing layer 16. As shown in FIG. 1, the laminated film 10 has a constitution in which the gas barrier layer 14 is laminated on both surfaces (both the main surfaces) of the sheet-like optically functional layer 12, and the entirety of the end face of a functional layer laminate 11 obtained by sandwiching the optically functional layer 12 between the gas barrier layers 14 is covered with the end face sealing layer 16.

The optically functional layer 12 is a layer for performing a desired function such as wavelength conversion, and a sheet-like material having a quadrangular planar shape, for example. In the following description, the optically functional layer 12 will be referred to as a functional layer 12 as well.

As the functional layer 12, it is possible to use various layers performing optical functions, such as a wavelength conversion layer like a quantum dot layer, a light extraction layer, and an organic electro luminescence layer (organic EL layer).

Particularly, by having the end face sealing layer 16, the functional layer 12 enables the characteristics of the laminated film of the present invention to be sufficiently exhibited, such as being able to prevent an optically functional material from deteriorating due to oxygen, water, or the like permeating from the end face. Therefore, a quantum dot layer, which is used in LCD or the like assumed to be used in various environments such as an in-vehicle environment with a high temperature and a high humidity and in which the deterioration of quantum dots resulting from oxygen becomes a big issue, can be suitably used as the functional layer 12.

For example, the quantum dot layer is a layer obtained by dispersing a large number of quantum dots in a matrix such as a resin, and is a wavelength conversion layer having a function of converting the wavelength of light incident on the functional layer 12 and emitting the light.

For instance, in a case where blue light emitted from a backlight not shown in the drawing is incident on the functional layer 12, by the effect of the quantum dots contained in the optically functional layer 12, the functional layer 12 performs wavelength conversion such that at least a portion of the blue light becomes red light or green light and emits the light.

Herein, the blue light refers to light having an emission wavelength centered at a wavelength range of 400 to 500 nm, the green light refers to light having an emission wavelength centered at a wavelength range of 500 to 600 nm, and the red light refers to light having an emission wavelength centered at a wavelength range of a wavelength of longer than 600 nm to a wavelength of equal to or shorter than 680 nm.

The function of wavelength conversion that the quantum dot layer performs is not limited to the constitution in which the wavelength conversion is performed to change the blue light into the red light or the green light, and at least a portion of incidence rays may be converted into light having a different wavelength.

The quantum dot emits fluorescence by being excited with at least excitation light incident thereon.

The type of the quantum dot contained in the quantum dot layer is not particularly limited, and according to the required wavelength conversion performance or the like, various known quantum dots may be appropriately selected.

Regarding the quantum dot, for example, paragraphs “0060” to “0066” in JP2012-169271A can be referred to, but the present invention is not limited thereto. As the quantum dot, commercially available products can be used without restriction. Generally, the emission wavelength of the quantum dot can be adjusted by the composition or size of the particles.

Although it is preferable that quantum dots are evenly dispersed in a matrix, the quantum dots may be unevenly dispersed in the matrix.

Furthermore, one kind of quantum dot may be used singly, or two or more kinds of quantum dots may be used in combination.

In a case where two or more kinds of quantum dots are used in combination, quantum dots that emit light having different wavelengths may be used.

Specifically, known quantum dots include a quantum dot (A) having an emission wavelength centered at a wavelength range of 600 to 680 nm, a quantum dot (B) having an emission wavelength centered at a wavelength range of 500 to 600 nm, and a quantum dot (C) having a emission wavelength centered at a wavelength range of 400 to 500 nm. The quantum dot (A) emits red light by being excited with excitation light, the quantum dot (B) emits green light, and the quantum dot (C) emits blue light. For example, in a case where blue light is caused to incident on a quantum dot-containing laminate containing the quantum dot (A) and the quantum dot (B) as excitation light, by the red light emitted from the quantum dot (A), the green light emitted from the quantum dot (B), and the blue light transmitted through the quantum dot layer, white light can be realized. Furthermore, in a case where ultraviolet light is caused to incident on the quantum dot layer containing the quantum dots (A), (B), and (C) as excitation light, by the red light emitted from the quantum dot (A), the green light emitted from the quantum dot (B), and the blue light emitted from the quantum dot (C), white light can be realized.

As a quantum dot, a so-called quantum rod which has a rod shape and emits polarized light with directionality or a tetrapod-type quantum dot may be used.

The type of the matrix of the quantum dot layer is not particularly limited, and various resins used in known quantum dot layers can be used.

Examples of the matrix include a polyester-based resin (for example, polyethylene terephthalate and polyethylene naphthalate), a (meth)acrylic resin, a polyvinyl chloride-based resin, a polyvinylidene chloride-based resin, and the like. Alternatively, as the matrix, it is possible to use a curable compound having a polymerizable group. The type of the polymerizable group is not particularly limited, but the polymerizable group is preferably a (meth)acrylate group, a vinyl group, or an epoxy group, more preferably a (meth)acrylate group, and particularly preferably an acrylate group. In a polymerizable monomer having two or more polymerizable groups, the polymerizable groups may be the same as or different from each other.

Specifically, for example, a resin containing a first polymerizable compound and a second polymerizable compound described below can be used as a matrix.

The first polymerizable compound is preferably one or more compounds selected from the group consisting of a (meth)acrylate monomer having two or more functional groups and a monomer having two or more functional groups selected from the group consisting of an epoxy group and an oxetanyl group.

Examples of the (meth)acrylate monomer having two or more functional groups preferably include difunctional (meth)acrylate monomers such as neopentyl glycol di(meth)acrylate, 1,9-nonanediol di(meth)acrylate, tripropylene glycol di(mcth)acrylate, ethylene glycol di(meth)acrylate, tetraethylene glycol di(meth)acrylate, hydroxypivalic acid neopentyl glycol di(meth)acrylate, polyethylene glycol di(meth)acrylate, dicyclopentenyl (meth)acrylate, dicyclopentenyloxyethyl (meth)acrylate, and dicyclopentanyl di(meth)acrylate.

Examples of the (meth)acrylate monomer having two or more functional groups preferably include (meth)acrylate monomers having three or more functional groups such as ECH-modified glycerol tri(meth)acrylate, EO-modified glycerol tri(meth)acrylate, PO-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl)isocyanurate, dipentaerythritol hexa(meth)acrylate, dipentaerythritol penta(meth)acrylate, caprolactone-modified dipentaerythritol hexa(meth)acrylate, dipentaerythritol hydroxypenta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy tetra(meth)acrylate, and pentaerythritol tetra(meth)acrylate.

As the monomer having two or more functional groups selected from the group consisting of an epoxy group and an oxetanyl group, an aliphatic cyclic epoxy compound, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 1,4-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers; polyglycidyl ethers of polyether polyol obtained by adding one kind or two or more kinds of alkylene oxide to an aliphatic polyhydric alcohol such as ethylene glycol, propylene glycol, or glycerin; diglycidyl esters of aliphatic long-chain dibasic acid; glycidyl esters of higher fatty acids; a compound containing epoxycycloalkane, and the like are suitably used.

Examples of commercially available products that can be suitably used as the monomer having two or more functional groups selected from the group consisting of an epoxy group and an oxetanyl group include CELLOXIDE 2021P and CELLOXIDE 8000 manufactured by Daicel Corporation, 4-vinylcyclohexene dioxide manufactured by Sigma-Aldrich Co. LLC., and the like. One kind of these monomers can be used singly, or two or more kinds of these monomers can be used in combination.

The monomer having two or functional groups selected from the group consisting of an epoxy group and an oxetanyl group may be prepared by any method. For example, the monomer can be synthesized with reference to the documents such as “Experimental Chemistry Course 20, Organic Synthesis II”, pp. 213-, 1992, MARUZEN SHUPPAN K.K, “The chemistry of heterocyclic compounds-Small Ring Heterocycles, part 3 Oxiranes”, Ed. By Alfred Hasfner, 1985, John & Wiley and sons, An Interscience Publication, New York, 1985, “Adhcsion”, Yoshimura, Vol. 29, No. 12, 32, 1985, “Adhesion”, Yoshimura, Vol. 30, No. 5, 42, 1986, “Adhesion”, Yoshimura, Vol. 30, No. 7, 42, 1986, JP1999-100378A (JP-H11-100378A), JP2906245B, and JP2926262B.

The second polymerizable compound has a functional group which has hydrogen bonding properties in a molecule and a polymerizable group which can cause a polymerization reaction with the first polymerizable compound.

Examples of the functional group having hydrogen bonding properties include a urethane group, a urea group, a hydroxyl group, and the like.

In a case where the first polymerizable compound is a (meth)acrylate monomer having two or more functional groups, the polymerizable group which can cause a polymerization reaction with the first polymerizable compound may be a (meth)acryloyl group, for example. In a case where the first polymerizable compound is a monomer having two or more functional groups selected from the group consisting of an epoxy group and an oxetanyl group, the polymerizable group which can cause a polymerization reaction may be an epoxy group or an oxetanyl group.

Examples of the (meth)acrylate monomer containing a urethane group include monomers and oligomers obtained by reacting diisocyanate such as TDI, MDI, HDI, IPDI, and HMDI with polyol such as poly(propyleneoxide)diol, poly(tetramethyleneoxide)diol, ethoxylated bisphenol A, ethoxylated bisphenol S spiroglycol, caprolactone-modified diol, and carbonate diol and hydroxyacrylate such as 2-hydroxyethyl (meth)acrylate, 2-hydroxypropyl (meth)acrylate, glycidol di(meth)acrylate, and pentaerythritol triacrylate, and polyfunctional urethane monomers described in JP2002-265650A, JP2002-355936A, JP2002-067238A, and the like. Specifically, examples thereof include an adduct of TDI and hydroxyethyl acrylate, an adduct of IPDI and hydroxyethyl acrylate, an adduct of HDI and pentaerythritol triacrylate (PETA), a compound obtained by making an adduct of TDI and PETA and reacting the remaining isocyanate with dodecyloxyhydroxypropyl acrylate, an adduct of 6,6 nylon and TDI, an adduct of pentaerythritol, TDI, and hydroxyethyl acrylate, and the like, but the present invention is not limited to these.

Examples of commercially available products that can be suitably used as the (meth)acrylate monomer containing a urethane group include AH-600, AT-600, UA-306H, UA-306T, UA-306I, UA-510H, UF-8001G, and DAUA-167 manufactured by KYOEISHA CHEMICAL Co., LTD, UA-160TM manufactured by SHIN-NAKAMURA CHEMICAL CO., LTD., UV-4108F and UV-4117F manufactured by OSAKA ORGANIC CHEMICAL INDUSTRY LTD, and the like. One kind of these monomers can be used singly, or two or more kinds of these monomers can be used in combination.

Examples of the (meth)acrylate monomer containing a hydroxyl group include a compound synthesized by causing a reaction between a compound having an epoxy group and (meth)acrylic acid. Typical examples of the monomer are classified into, depending on the compound having an epoxy group, a bisphenol A type, a bisphenol S type, a bisphenol F type, an epoxidized oil type, a phenol novolac type, and alicyclic type. Specific examples of the monomer include (meth)acrylate obtained by reacting an adduct of bisphenol A and epichlorohydrin with (meth)acrylic acid, (meth)acrylate obtained by reacting phenol novolac with epichlorohydrin and then reacting the product with (meth)acrylic acid, (meth)acrylate obtained by reacting an adduct of bisphenol S and epichlorohydrin with (meth)acrylic acid, (meth)acrylate obtained by reacting epoxidized soybean oil with (meth)acrylic acid, and the like. Examples of the (meth)acrylate monomer having a hydroxyl group also include a (meth)acrylate monomer having a carboxyl group or a phosphoric acid group on the terminal, and the like, but the present invention is not limited thereto.

Examples of commercially available products that can be suitably used as the second polymerizable compound containing a hydroxyl group include epoxy ester, M-600A, 40EM, 70PA, 200PA, 80MFA, 3002M, 3002A, 3000MK, and 3000A manufactured by KYOEISHA CHEMICAL Co., LTD, 4-hydroxybutyl acrylate manufactured by Nippon Kasei Chemical Co., Ltd, monofunctional acrylate A-SA and monofunctional methacrylate SA manufactured by SHIN-NAKAMURA CHEMICAL CO., LTD., monofunctional acrylate 3-carboxyethyl acrylate manufactured by DAICEL-ALLNEX LTD., JPA-514 manufactured by JOHOKU CHEMICAL CO., LTD, and the like. One kind of these can be used singly, or two or more kinds of these can be used in combination.

A mass ratio of first polymerizable compound:second polymerizable compound may be 10:90 to 99:1, and is preferably 10:90 to 90:10. It is preferable that the content of the first polymerizable compound is greater than the content of the second polymerizable compound. Specifically, (content of first polymerizable compound)/(content of second polymerizable compound) is preferably 2 to 10.

In a case where a resin containing the first polymerizable compound and the second polymerizable compound is used as a matrix, it is preferable that the matrix further contains a monofunctional (meth)acrylate monomer. Examples of the monofunctional (meth)acrylate monomer include acrylic acid, methacrylic acid, and derivatives of these, and more specifically include a monomer having one polymerizable unsaturated bond ((meth)acryloyl group) of (meth)acrylic acid in a molecule. Specific examples of the monomer include the following compounds, but the present invention is not limited thereto.

Examples of the monomer include alkyl (meth)acrylate containing an alkyl group having 1 to 30 carbon atoms such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate; aralkyl (meth)acrylate containing an aralkyl group having 7 to 20 carbon atoms, such as benzyl (meth)acrylate; alkoxyalkyl (meth)acrylate containing an alkoxyalkyl group having 2 to 30 carbon atoms, such as butoxyethyl (meth)acrylate; aminoalkyl (meth)acrylate containing a (monoalkyl or dialkyl) aminoalkyl group having 1 to 20 carbon atoms in total, such as N,N-dimethylaminoethyl (meth)acrylate; (meth)acrylate of polyalkylene glycol alkyl ether containing an alkylene chain having 1 to 10 carbon atoms and terminal alkyl ether having 1 to 10 carbon atoms, such as (meth)acrylate of diethylene glycol ethyl ether, (meth)acrylate of triethylene glycol butyl ether, (meth)acrylate of tetraethylene glycol monomethyl ether, (meth)acrylate of hexaethylene glycol monomethyl ether, monomethyl ether (meth)acrylate of octaethylene glycol, monomethyl ether (meth)acrylate of nonaethylene glycol, monomethyl ether (meth)acrylate of dipropylene glycol, monomethyl ether (meth)acrylate of heptapropylene glycol, and monoethyl ether (meth)acrylate of tetraethylene glycol; (meth)acrylate of polyalkylene glycol aryl ether containing an alkylene chain having 1 to 30 carbon atoms and terminal aryl ether having 6 to 20 carbon atoms, such as (meth)acrylate of hexaethylene glycol phenyl ether; (meth)acrylate having an alicyclic structure containing 4 to 30 carbon atoms in total, such as cyclohexyl (meth)acrylate, dicyclopentanyl (meth)acrylate, isobornyl (meth)acrylate, and methylene oxide-added cyclodecatriene (meth)acrylate; fluorinated alkyl (meth)acrylate having 4 to 30 carbon atoms in total such as heptadecafluorodecyl (meth)acrylate; (meth)acrylate having a hydroxyl group such as 2-hydroxyethyl (meth)acrylate, 3-hydroxypropyl (meth)acrylate, 4-hydroxybutyl (meth)acrylate, mono(meth)acrylate of triethylene glycol, tetraethylene glycol mono(meth)acrylate, hexaethylene glycol mono(meth)acrylate, octapropylene glycol mono(meth)acrylate, and mono- or di(meth)acrylate of glycerol; (meth)acrylate having a glycidyl group such as glycidyl (meth)acrylate; polyethylene glycol mono(meth)acrylate having an alkylene chain containing 1 to 30 carbon atoms, such as tetraethylene glycol mono(meth)acrylate, hexaethylene glycol mono(meth)acrylate, and octapropylene glycol mono(meth)acrylate; (meth)acrylamide such as (meth)acrylamide, N,N-dimethyl (meth)acrylamide, N-isopropyl (meth)acrylamide, 2-hydroxyethyl (meth)acrylamide, and acryloylmorpholine; and the like.

The content of the monofunctional (meth)acrylate monomer with respect to the total mass (100 parts by mass) of the first polymerizable compound and the second polymerizable compound is preferably 1 to 300 parts by mass, and more preferably 50 to 150 parts by mass.

Furthermore, it is preferable that the matrix contains a compound having a long-chain alkyl group containing 4 to 30 carbon atoms. Specifically, it is preferable that at least any one of the first polymerizable compound, the second polymerizable compound, or the monofunctional (meth)acrylate monomer has a long-chain alkyl group having 4 to 30 carbon atoms. It is preferable that long-chain alkyl group is a long-chain alkyl group having 12 to 22 carbon atoms, because then the dispersibility of the quantum dots is improved. The further the dispersibility of the quantum dots is improved, the further the amount of light that goes straight to an emission surface from a light conversion layer increases. Accordingly, the improvement of the dispersibility of the quantum dots is effective for improving front luminance and front contrast.

Specifically, as the monofunctional (meth)acrylate monomer having a long-chain alkyl group containing 4 to 30 carbon atoms, butyl (meth)acrylate, octyl (meth)acrylate, lauryl (meth)acrylate, oleyl (meth)acrylate, stearyl (meth)acrylate, behenyl (meth)acrylate, butyl (meth)acrylamide, octyl (meth)acrylamide, lauryl (meth)acrylamide, oleyl (meth)acrylamide, stearyl (meth)acrylamide, behenyl (meth)acrylamide, and the like are preferable. Among these, lauryl (meth)acrylate, oleyl (meth)acrylate, and stearyl (meth)acrylate are particularly preferable.

Furthermore, the resin which becomes a matrix may contain a compound having a fluorine atom such as trifluoroethyl (meth)acrylate, pentafluoroethyl (meth)acrylate, (perfluorobutyl)ethyl (meth)acrylate, perfluorobutyl-hydroxypropyl (meth)acrylate, (perfluorohexyl)ethyl (meth)acrylate, octafluoropentyl (meth)acrylate, perfluorooctyl ethyl (meth)acrylate, and tetrafluoropropyl (meth)acrylate. In a case where the resin contains these compounds, the coating properties can be further improved.

The total amount of the resin, which becomes a matrix, in the quantum dot layer is not particularly limited. The total amount of the resin with respect to a total of 100 parts by mass of the quantum dot layer is preferably 90 to 99.9 parts by mass, and more preferably 92 to 99 parts by mass.

The thickness of the quantum dot layer may be appropriately set according to the thickness of the laminated film 10 or the like. According to the examination performed by the inventors of the present invention, in view of handleability and emission characteristics, the thickness of the quantum dot layer is preferably 5 to 200 μm, and more preferably 10 to 150 μm.

The aforementioned thickness means an average thickness which can be determined by measuring thicknesses of ten or more random spots in the quantum dot layer and calculating an arithmetic mean thereof.

The method for forming the quantum dot layer is not particularly limited, and the quantum dot layer may be formed by a known method. For example, the quantum dot layer can be formed by preparing a composition (paint-coating composition) by means of mixing quantum dots, a resin which becomes a matrix, and a solvent together, coating the gas barrier layer 14 with the composition, and curing the composition.

If necessary, a polymerization initiator, a silane coupling agent, and the like may be added to the composition that becomes the quantum dot layer.

In the laminated film 10, on both surfaces of the functional layer 12 such as a quantum dot layer, the gas barrier layer 14 is laminated such that the entirety of the main surfaces of the functional layer 12 is covered. That is, the laminated film 10 has a constitution in which the functional layer 12 is sandwiched between the gas barrier layers 14.

Herein, as a preferred aspect, the laminated film 10 shown in the drawing includes the gas barrier layer 14 provided on both surfaces of the functional layer 12, but the present invention is not limited thereto. That is, the gas barrier layer 14 may be provided on only one surface of the functional layer 12. However, it is preferable that the gas barrier layer 14 is provided on both surfaces of the functional layer 12, because then the deterioration of the functional layer 12 resulting from oxygen or the like can be more suitably prevented.

In a case where the gas barrier layer 14 is provided on both surfaces of the functional layer 12, the gas barrier layers 14 may be the same as or different from each other.

The gas barrier layer 14 is a layer for inhibiting the permeation of oxygen or the like from the main surface of the functional layer 12 such as a quantum dot layer. Accordingly, it is preferable that the gas barrier layer 14 has high gas barrier properties. Specifically, an oxygen permeability of the gas barrier layer 14 is preferably equal to or lower than 0.1 cc/(m²·day·atm), more preferably equal to or lower than 0.01 cc/(m²·day·atm), and particularly preferably equal to or lower than 0.001 cc/(m²·day·atm).

In a case where the oxygen permeability of the gas barrier layer 14 is equal to or lower than 0.1 cc/(m²·day·atm), it is possible to inhibit the functional layer 12 from deteriorating due to oxygen or the like permeating from the main surface of the functional layer 12 and to obtain a laminated film such as a quantum dot film having long service life.

In the present invention, the oxygen permeability of the gas barrier layer 14, the end face sealing layer 16, or the like may be measured based on examples which will be described later.

Furthermore, the unit cc/(m²·day·atm) of oxygen permeability is expressed as 9.87 mL/(m²·day·MPa) in terms of the SI unit.

As the gas barrier layer 14, various materials such as a layer (film) formed of a known material exhibiting gas barrier properties and a known gas barrier film can be used, as long as the materials have sufficient optical characteristics in view of transparency or the like and yield intended gas barrier properties (oxygen barrier properties).

Particularly, as a preferred gas barrier layer 14, a gas barrier film can be exemplified which has an organic and inorganic laminated structure obtained by alternately laminating an organic layer and an inorganic layer on a support (on one surface or both surfaces of a support).

FIG. 2 schematically shows a cross-section of an example of the gas barrier layer 14.

The gas barrier layer 14 shown in FIG. 2 has an organic layer 24 on a support 20, an inorganic layer 26 on the organic layer 24, and an organic layer 28 on the inorganic layer 26.

In the gas barrier layer 14 (gas barrier film), gas barrier properties are mainly exhibited by the inorganic layer 26. The organic layer 24 as an underlayer of the inorganic layer 26 is an underlayer for appropriately forming the inorganic layer 26. The organic layer 28 as an uppermost layer functions as a protective layer for the inorganic layer 26.

In the laminated film of the present invention, the gas barrier film, which is used as the gas barrier layer 14 and has an organic and inorganic laminated structure, is not limited to the example shown in FIG. 2.

For example, the gas barrier layer 14 may not have the organic layer 28 as an uppermost layer that functions as a protective layer.

Furthermore, although the gas barrier layer 14 in example shown in FIG. 2 has only one combination of the inorganic layer and the organic layer as a base, the gas barrier layer 14 may have two or more combinations of the inorganic layer and the organic layer as a base. Generally, the larger the number of combinations of the inorganic layer and the organic layer as a base, the higher the gas barrier properties.

In addition, a constitution may be adopted in which an inorganic layer is formed on the support 20, and one or more combinations of an inorganic layer and an organic layer as a base are provided on the aforementioned inorganic layer.

As the support 20 of the gas barrier layer 14, it is possible to use various materials that are used as a support in known gas barrier films.

Among these, films formed of various resin materials (polymer materials) are suitably used, because these films make it easy to obtain a thin or lightweight support and are suitable for making a flexible support.

Specifically, plastic films formed of polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, a polymethyl methacrylate resin (PMMA), polycarbonate (PC), polyacrylate, polymethacrylate, polypropylene (PP), polystyrene (PS), ABS, a cycloolefin copolymer (COC), a cycloolefin polymer (COP), and triacetyl cellulose (TAC) can be suitably exemplified.

The thickness of the support 20 may be appropriately set according to the thickness, size, and the like of the laminated film 10. According to the examination performed by the inventors of the present invention, the thickness of the support 20 is preferably about 10 m to 100 μm. In a case where the thickness of the support 20 is within the above range, in view of making a lightweight or thin support, preferable results are obtained.

To the surface of the plastic film of which the support 20 is formed, the functions of preventing reflection, controlling phase difference, improving light extraction efficiency, and the like may be imparted.

In the gas barrier layer 14, the organic layer 24 is formed on the surface of the support 20.

The organic layer 24 formed on the surface of the support 20, that is, the organic layer 24 which becomes an underlayer of the inorganic layer 26 is an underlayer of the inorganic layer 26 mainly exhibiting gas barrier properties in the gas barrier layer 14.

In a case where the gas barrier layer 14 has the organic layer 24, the surface asperities of the support 20, foreign substances having adhered to the surface of the support 20, and the like are concealed, and hence a deposition surface for the inorganic layer 26 can be in a state suitable for forming the inorganic layer 26. Accordingly, it is possible to form an appropriate inorganic layer 26 without voids on the entire surface of the substrate, by removing regions, on which an inorganic compound that becomes the inorganic layer 26 is not easily deposited as a film, such as surface asperities or shadows of foreign substances on the support 20. As a result, a gas barrier layer 14 having an oxygen permeability of equal to or lower than 0.1 cc/(m²·day·atm) can be stably formed.

In the gas barrier layer 14, as the material for forming the organic layer 24, various known organic compounds can be used without restriction.

Specifically, thermoplastic resins such as polyester, a (meth)acrylic resin, a methacrylic acid-maleic acid copolymer, polystyrene, a transparent fluorine resin, polyimide, fluorinated polyimide, polyamide, polyamide imide, polyether imide, cellulose acylate, polyurethane, polyether ether ketone, polycarbonate, alicyclic polyolefin, polyarylate, polyether sulfone, polysulfone, fluorene ring-modified polycarbonate, alicyclic ring-modified polycarbonate, fluorene ring-modified polyester, and an acryl compound, polysiloxane, and films of other organic silicon compounds can be suitably exemplified. A plurality of these materials may be used in combination.

Among these, in view of excellent glass transition temperature or hardness, an organic layer 24 is suitable which is constituted with a polymer of a radically curable compound and/or a cationically curable compound having an ether group as a functional group.

Particularly, an acrylic resin or a methacrylic resin, which contains a polymer of a monomer or an oligomer of acrylate and/or methacrylate as a main component, can be suitably exemplified as the organic layer 24, because such a resin has low refractive index, high transparency, excellent optical characteristics, and the like.

Especially, an acrylic resin or a methacrylic resin can be suitably exemplified which contains, as a main component, a polymer of a monomer or an oligomer of acrylate and/or methacrylate having two or more functional groups, particularly, three or more functional groups, such as dipropylene glycol di(meth)acrylate (DPGDA), trimethylolpropane tri(meth)acrylate (TMPTA), or dipentaerythritol hexa(meth)acrylate (DPHA). Furthermore, it is preferable to use a plurality of acrylic resins or methacrylic resins described above.

The thickness of the organic layer 24 may be appropriately set according to the material for forming the organic layer 24 or the support 20. According to the examination performed by the inventors of the present invention, the thickness of the organic layer 24 is preferably 0.5 to 5 μm, and more preferably 1 to 3 μm.

In a case where the thickness of the organic layer 24 is equal to or greater than 0.5 μm, the surface of the organic layer 24, that is, the deposition surface for the inorganic layer 26 can be smoothed by concealing the surface asperities of the support 20 or the foreign substances having adhered to the surface of the support 20. In a case where the thickness of the organic layer 24 is equal to or smaller than 5 μm, it is possible to suitably inhibit the occurrence of problems such as cracking of the organic layer 24 caused in a case where the organic layer 24 is too thick and curling caused by the gas barrier layer 14.

In a case where the gas barrier film has a plurality of organic layers, such as a case where the gas barrier film has a plurality of combinations of an inorganic layer and an organic layer as a base, the organic layers may have the same thickness or different thicknesses.

The organic layer 24 may be formed by a known method such as a coating method or a flash vapor deposition method.

In order to improve the adhesiveness between the organic layer 24 and the inorganic layer 26 that becomes the underlayer of the organic layer 24, it is preferable that the organic layer 24 (composition that becomes the organic layer 24) contains a silane coupling agent.

In a case where the gas barrier film has a plurality of organic layers 24, such as a case where the gas barrier film has a plurality of combinations of an inorganic layer and an organic layer as a base including the organic layer 28 which will be described later, the organic layers may be formed of the same material or different materials. However, in view of productivity and the like, it is preferable that all the organic layers are formed of the same material.

On the organic layer 24, the inorganic layer 26 is formed using the organic layer 24 as a base.

The inorganic layer 26 is a film containing an inorganic compound as a main component and mainly exhibits gas barrier properties in the gas barrier layer 14.

As the inorganic layer 26, various films can be used which exhibit gas barrier properties and are formed of an inorganic compound such as an oxide, a nitride, or an oxynitride.

Specifically, films formed of inorganic compounds including a metal oxide such as aluminum oxide, magnesium oxide, tantalum oxide, zirconium oxide, titanium oxide, an indium tin oxide (ITO); a metal nitride such as aluminum nitride; a metal carbide such as aluminum carbide; an oxide of silicon such as silicon oxide, silicon oxynitride, silicon oxycarbide, and silicon oxynitrocarbide; a nitride of silicon such as silicon nitride and silicon nitrocarbide; a carbide of silicon such as silicon carbide; hydroxides of these; a mixture of two or more kinds of these; and hydrogenous substances of these can be suitably exemplified.

Particularly, films formed of a silicon compound such as an oxide of silicon, a nitride of silicon, and an oxynitride of silicon can be suitably exemplified, because these films have high transparency and can exhibit excellent gas barrier properties. Among these, a film formed of silicon nitride can be particularly suitably exemplified because this film exhibits better gas barrier properties and has high transparency.

The thickness of the inorganic layer 26 may be appropriately determined according to the material for forming the inorganic layer 26, such that intended gas barrier properties can be exhibited. According to the examination performed by the inventors of the present invention, the thickness of the inorganic layer 26 is preferably 10 to 200 nm, more preferably 10 to 100 nm, and particularly preferably 15 to 75 nm.

In a case where the thickness of the inorganic layer 26 is equal to or greater than 10 nm, an inorganic layer 26 stably demonstrating a sufficient gas barrier performance can be formed. Generally, in a case where the inorganic layer 26 is brittle and too thick, the inorganic layer 26 is likely to experience cracking, fissuring, peeling and the like. However, in a case where the thickness of the inorganic layer 26 is equal to or smaller than 200 nm, the occurrence of cracks can be prevented.

In a case where the gas barrier film has a plurality of inorganic layers 26, the inorganic layers 26 may have the same thickness or different thicknesses.

The inorganic layer 26 may be formed by a known method according to the material forming the inorganic layer 26. Specifically, plasma CVD such as capacitively coupled plasma (CCP)-chemical vapor deposition (CVD) or inductively coupled plasma (ICP)-CVD, sputtering such as magnetron sputtering or reactive sputtering, and a vapor-phase deposition method such as vacuum vapor deposition can be suitably exemplified.

In a case where the gas barrier film has a plurality of inorganic layers, the inorganic layers may be formed of the same material or different materials. However, in view of productivity and the like, it is preferable that all the inorganic layers are formed of the same material.

The organic layer 28 is provided on the inorganic layer 26.

As described above, the organic layer 28 is a layer functioning as a protective layer for the inorganic layer 26. In a case where the organic layer 28 is provided as an uppermost layer, the damage of the inorganic layer 26 exhibiting gas barrier properties can be prevented, and hence the gas barrier layer 14 can stably exhibit intended gas barrier properties.

The organic layer 28 is basically the same as the aforementioned organic layer 24.

The thickness of the gas barrier layer 14 may be appropriately set according to the thickness of the laminated film 10, the size of the laminated film 10, and the like.

According to the examination performed by the inventors of the present invention, the thickness of the gas barrier layer 14 is preferably 5 to 100 μm, more preferably 10 to 70 μm, and particularly preferably 15 to 55 μm.

In a case where the thickness of the gas barrier layer 14 is equal to or smaller than 100 μm, it is possible to prevent the gas barrier layer 14, that is, the laminated film 10 from becoming unnecessarily thick. Furthermore, it is preferable that the thickness of the gas barrier layer 14 is equal to or greater than 5 μm, because then the thickness of the functional layer 12 can be made uniform at the time of forming the functional layer 12 between two gas barrier layers 14.

In the example shown in the drawing, the functional layer laminate 11 is constituted with two gas barrier layers 14 and the functional layer 12. However, layers for obtaining various functions such as a diffusion layer, an anti-Newton ring layer, a protective layer, and an adhesive layer may also be laminated.

As described above, the laminated film 10 has a constitution in which the gas barrier layer 14 is laminated on both surfaces of the functional layer 12, and the entirety of the end face of the functional layer laminate 11 including the functional layer 12 and the gas barrier layers 14 is sealed with the end face sealing layer 16.

In a preferred aspect, the laminated film 10 illustrated in the drawing has a constitution in which the entirety of the end face of the functional layer laminate 11 including the functional layer 12 and the gas barrier layers 14 is sealed with the end face sealing layer 16. However, the present invention is not limited thereto, and at least the end face of the functional layer laminate 11, a portion of the gas barrier layers 14, and the entirety of the end face of the functional layer 12 may be covered with the end face scaling layer 16.

In a case where the constitution is adopted in which at least the end face of the functional layer laminate 11, a portion of the gas barrier layers 14, and the entirety of the end face of the functional layer 12 are covered with the end face sealing layer 16 having gas barrier properties, it is possible to prevent the optically functional layer 12 such as a quantum dot layer performing an optical function from deteriorating due to the permeation of oxygen or the like from the end face, and to enhance the flatness of the laminated film.

The end face sealing layer preferably covers the end face of the functional layer laminate 11 in as large area as possible and particularly preferably covers the entirety of the end face of the functional layer laminate 11, because then the functional layer 12 such as a quantum dot layer can be more suitably prevented from deteriorating due to oxygen or the like permeating from the end face of the functional layer laminate 11.

In the laminated film 10 of the present invention, the thickness of the end face sealing layer 16 in a direction perpendicular to the end face of the functional layer laminate 11 is preferably equal to or smaller than ½ of the thickness of the functional layer laminate 11 in a direction perpendicular to the main surface of the functional layer laminate 11.

This point will be described using FIG. 3A.

FIG. 3A is an enlarged schematic view showing the edge of the functional layer laminate 11 on which the end face sealing layer 16 is formed.

As shown in FIG. 3A, provided that the thickness of the functional layer laminate 11 in a direction perpendicular to the main surface of the functional layer laminate 11 is T, and that the thickness (maximum thickness) of the end face sealing layer 16 in a direction perpendicular to the end face of the functional layer laminate 11 is R, the thickness R of the end face sealing layer 16 is preferably equal to or smaller than ½ of the thickness T of the functional layer laminate 11.

According to the examination performed by the inventors of the present invention, because the functional layer laminate containing quantum dots is extremely thin, it is difficult to provide the end face sealing layer only on the end face of the thin functional layer laminate, and hence the sealing layer may also be formed on the main surface side of the functional layer laminate.

In a case where the sealing layer is formed on the main surface side of the functional layer laminate, the flatness of the laminated film deteriorates, or the thickness of the laminated film increases. In a case where such a laminated film having poor flatness is laminated on other optical films at the time of being incorporated into LCD or the like, the laminated film itself or other optical films are curved, and hence appropriate performance could not be demonstrated. Furthermore, the thickening of the laminated film is unfavorable for making a thin LCD.

In contrast, in a suitable aspect of the present invention, a constitution is adopted in which the thickness R of the end face sealing layer 16 covering at least a portion of the end face of the functional layer laminate 11 is equal to or smaller than ½ of the thickness T of the functional layer laminate 11.

In a case where the thickness R of the end face sealing layer 16 is equal to or smaller than ½ of the thickness T of the functional layer laminate 11, it is possible to inhibit the formation of the end face sealing layer 16 on the main surface side of the functional layer laminate and to form the end face sealing layer only on the end face of a thin laminated film.

This point will be described using FIGS. 3A and 3B.

The coating composition, with which the end face of the functional layer laminate 11 is coated at the time of forming the end face sealing layer 16 and which becomes the end face sealing layer 16, has an approximately semicircular cross-sectional shape due to surface tension. At this time, in a case where the end face of the functional layer laminate 11 is coated with the coating composition such that the thickness R of the end face sealing layer 16 becomes greater than ½ of the thickness T of the functional layer laminate 11, the diameter of the semicircle of the cross-sectional shape of the coating composition (end face sealing layer 16) becomes greater than the thickness T of the functional layer laminate 11 as shown in FIG. 3B. Therefore, the coating composition wraps much both the main surfaces (surface of the gas barrier layers 14) of the functional layer laminate 11, and consequently, the end face sealing layer 16 is formed on both the main surfaces of the functional layer laminate 11. Accordingly, a width D of the end face sealing layer 16 (a width in a direction perpendicular to the main surface of the functional layer laminate 11) becomes greater than the thickness T of the functional layer laminate 11.

In contrast, in a case where the end face of the functional layer laminate 11 is coated with the coating composition such that the thickness R of the end face sealing layer 16 becomes equal to or smaller than ½ of the thickness T of the functional layer laminate 11, the diameter of the semicircle of the cross-sectional shape of the coating composition (end face sealing layer 16) becomes smaller than the thickness T of the functional layer laminate 11 as shown in FIG. 3A. Therefore, it is difficult for the coating composition to wrap both the main surfaces of the functional layer laminate 11 and for the end face sealing layer 16 to be formed on both the main surfaces of the functional layer laminate 11.

Accordingly, it is possible to prevent oxygen or the like from permeating from the end face, to prevent the deterioration of the optically functional layer such as a quantum dot performing an optical function, and to improve the flatness. Furthermore, it is possible to appropriately laminate the laminated film on other optical films by inhibiting the film from curving at the time of being incorporated into the film into LCD or the like, and to prevent the increase in the thickness.

The end face sealing layer 16 is formed of a material having gas barrier properties. Specifically, the end face sealing layer 16 is a resin layer having an oxygen permeability of equal to or lower than 10 cc/(m²·day·atm). Because the laminated film 10 of the present invention has such an end face sealing layer 16, the member such as a quantum dot layer performing an optical function is prevented from deteriorating due to oxygen or the like that permeates the optically functional layer 12 from the end face not covered with the gas barrier layer 14.

In a case where the oxygen permeability of the end face sealing layer 16 in the laminated film 10 of the present invention is higher than 10 cc/(m²·day·atm), oxygen or the like permeating the functional layer 12 from the end face of the laminate cannot be sufficiently prevented, and hence the functional layer 12 deteriorates within a short time.

Considering the above point, it is preferable that the oxygen permeability of the end face sealing layer 16 is low. Specifically, the oxygen permeability of the end face sealing layer 16 is preferably equal to or lower than 5 cc/(m²·day·atm), and more preferably equal to or lower than 1 cc/(m²·day·atm).

The lower limit of the oxygen permeability of the end face sealing layer 16 is not particularly limited. However, basically, it is preferable that the lower limit of the oxygen permeability is low.

As described above, the thickness R of the end face sealing layer 16 is preferably equal to or smaller than ½ of the thickness T of the functional layer laminate 11. However, from the viewpoint of gas barrier properties, the end face sealing layer 16 is preferably thick. Accordingly, the thickness R of the end face sealing layer 16 may be appropriately set according to the material forming the end face sealing layer 16 and the like, such that the thickness R of the end face sealing layer 16 becomes equal to or smaller than ½ of the thickness T of the functional layer laminate 11 and that the oxygen permeability becomes equal to or lower than 10 cc/(m²·day·atm).

Specifically, from the viewpoint of flatness, coating properties, adhesiveness, and the like, the thickness R of the end face sealing layer 16 is preferably 1 μm to 200 μm, and more preferably 10 μm to 100 μm.

It is preferable that the thickness R of the end face sealing layer 16 is equal to or greater than 1 μm, because then the end face sealing layer 16 can be stably formed which appropriately covers the end face of the laminate and has an oxygen permeability of equal to or lower than 10 cc/(m²·day·atm), and coating properties become excellent.

Furthermore, it is preferable that the thickness of the end face sealing layer 16 is equal to or smaller than 200 μm, because then the end face sealing layer can exhibit sufficient adhesiveness with respect to the laminate.

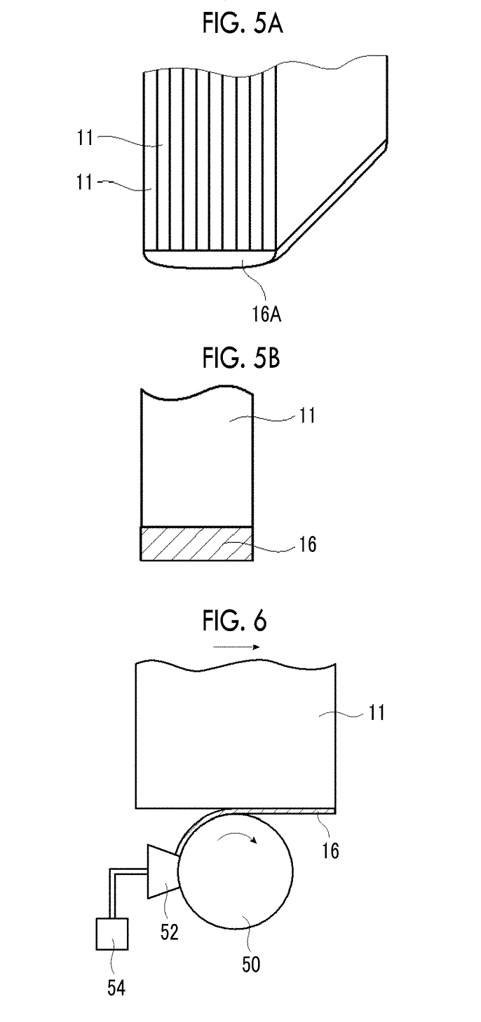

In the example shown in FIG. 1, a constitution is illustrated in which in a cross-section perpendicular to the extension direction of the end face of the functional layer laminate 11, the shape of the end face sealing layer 16 (hereinafter, referred to as a cross-sectional shape of the end face sealing layer as well) is an approximately semicircular. However, the present invention is not limited thereto, and the cross-sectional shape of the end face sealing layer may be a shape formed of a portion of a circle, a semielliptical shape, a semi-rounded rectangular shape (semiovale shape), a shape formed of a portion of these shapes, or an approximately rectangular shape as shown in FIG. 5B which will be described later.

From the viewpoint of securing more suitable flatness, the shape of the end face sealing layer 16 is preferably a shape formed of a portion of a circle.

In the example shown in FIG. 1, the end face sealing layer 16 is constituted with one layer. However, the present invention is not limited thereto, and the end face sealing layer 16 may have a laminated structure in which two or more layers are laminated in a direction perpendicular to the end face of the functional layer laminate 11.

In a case where the end face sealing layer 16 has a laminated structure including two or more layers, by separately imparting a desired function to each layer, the gas barrier properties can be further improved than in a case where the end face sealing layer 16 is constituted with a single layer. For example, in a case where a water-soluble material which exhibits low oxygen permeability at a low humidity and high oxygen permeability at a high humidity is used for the first layer, by providing a moisture barrier layer as the second layer, it is possible to make the first layer exhibit low oxygen permeability regardless of humidity. Alternatively, for example, in a case where the adhesiveness between a layer having low oxygen permeability and the functional layer laminate 11 (optically functional layer 12) is poor, it is possible to adopt a constitution in which an adhesive layer is provided between the layer having low oxygen permeability and the functional layer laminate 11. In addition, the end face sealing layer 16 may be constituted with three layers including an adhesive layer, a layer having low oxygen permeability, and a moisture barrier layer.

The end face sealing layer 16 described above, that is, the resin layer sealing the end face of the functional layer laminate 11 can be formed of various known resin materials that can form the end face sealing layer 16 having an oxygen permeability of equal to or lower than 10 cc/(m²·day·atm).

Generally, the end face sealing layer 16 is preferably formed by preparing a composition, which contains a compound (a monomer, a dimer, a trimer, an oligomer, a polymer, or the like) that is mainly formed into the end face sealing layer 16, that is, a resin layer, additives that are added if necessary such as a cross-linking agent and a surfactant, an organic solvent, and the like, coating the surface for forming the end face sealing layer 16 with the composition, drying the composition, and, if necessary, polymerizing (cross-linking·curing) the compound mainly constituting the resin layer by ultraviolet ray irradiation, heating, or the like.

The composition forming the end face sealing layer 16 in the laminated film 10 of the present invention contains the hydrogen bonding compound, preferably in an amount of equal to or greater than 30 parts by mass and more preferably in an amount of equal to or greater than 40 parts by mass provided that the total amount of solid contents in the composition is 100 parts by mass.

The total amount of solid contents of the composition is the total amount of components that should remain in the end face sealing layer 16 to be formed, except for an organic solvent in the composition.

It is preferable that the solid contents in the composition forming the end face sealing layer 16 contain a hydrogen bonding compound in an amount of equal to or greater than 30 parts by mass, because then the oxygen permeability can be reduced by strengthening the intermolecular interaction or the like.

A hydrogen bond refers to a non-covalent bond that is formed between a hydrogen atom, which forms a covalent bond with an atom having electronegativity higher than that of the hydrogen atom in a molecule, and another atom or atomic group in the same molecule or different molecules by attractive interaction.

The functional group having hydrogen bonding properties is a functional group containing a hydrogen atom which can form such a hydrogen bond. Specific examples of the functional group include a urethane group, a urea group, a hydroxyl group, a carboxyl group, an amide group, a cyano group, and the like.

Specific examples of compounds having these functional groups include monomers and oligomers which are obtained by reacting diisocyanate such as tolylene diisocyanate (TDI), diphenylmethane diisocyanate (MDI), hexamethylene diisocyanate (HDI), isophorone diisocyanate (IPDI), and hydrogenated MDI (HMDI) with polyol such as poly(propyleneoxide)diol, poly(tetramethyleneoxide)diol, ethoxylated bisphcnol A, ethoxylated bisphenol S spiroglycol, caprolactone-modified diol, and carbonate diol and hydroxyacrylate such as 2-hydroxyethyl (meth)acrylate, 2-hydroxypropyl (meth)acrylate, glycidyl di(meth)acrylate, and pentaerythritol triacrylate.

Examples of the aforementioned compounds also include an epoxy compound obtained by reacting a compound having an epoxy group with a compound such as a bisphenol A-type compound, a bisphenol S-type compound, a bisphenol F-type compound, an epoxidized oil-type compound, and a phenol novolac-type compound and an epoxy compound obtained by reacting alicyclic epoxy with an amine compound, an acid anhydride, and the like.

Examples of the aforementioned compounds also include a cationically polymerized substance of the aforementioned epoxy compound, polyvinyl alcohol (PVA), an ethylene-vinyl alcohol copolymer (EVOH), a butenediol-vinyl alcohol copolymer, polyacrylonitrile, and the like.

Among these, a compound having an epoxy group and a compound obtained by reacting a compound having an epoxy group are preferable, because these compounds less experience cure shrinkage and have excellent adhesiveness with respect to the laminated film.

Provided that the total amount of solid contents in the composition is 100 parts by mass, the composition forming the end face sealing layer 16 in the laminated film 10 of the present invention preferably contains either a resin composition selected from the group consisting of a polyvinyl alcohol-based resin, a polyvinylidene chloride resin, polyacrylonitrile, a polyvinylidene fluoride resin, and polyoxymethylene or a polymerizable compound having at least one polymerizable functional group selected from a (meth)acryloyl group, a vinyl group, a glycidyl group, an oxetane group, and an alicyclic epoxy group in an amount of equal to or greater than 5 parts by mass, and more preferably contains the polymerizable compound having these polymerizable functional group in an amount of equal to or greater than 10 parts by mass.

In the laminated film 10 of the present invention, in a case where the solid contents in the composition forming the end face sealing layer 16 contains the polymerizable compound having at least one polymerizable functional group selected from a (meth)acryloyl group and the like in an amount of equal to or greater than 5 parts by mass, an end face sealing layer 16 exhibiting excellent durability at a high temperature and a high humidity can be realized.

Specific examples of the polymerizable compound having a (meth)acryloyl group include neopentyl glycol di(meth)acrylate, 1,9-nonanediol di(meth)acrylate, tripropylene glycol di(meth)acrylate, ethylene glycol di(meth)acrylate, dicyclopentenyl (meth)acrylate, dicyclopentenyloxyethyl (meth)acrylate, dicyclopentanyl di(meth)acrylate, and the like.

Specific examples of the polymerizable compound having a glycidyl group, an oxetane group, an alicyclic epoxy group, or the like include bisphenol A diglycidyl ether, bisphenol F diglycidyl ether, hydrogenated bisphenol A diglycidyl ether, hydrogenated bisphenol F diglycidyl ether, 1,4-butanediol diglycidyl ether, 1,6-hexanediol diglycidyl ether, glycerin triglycidyl ether, trimethylolpropane triglycidyl ether, and the like.

In the present invention, as the polymerizable compound having a (meth)acryloyl group or a glycidyl group, commercially available products can be suitably used.

As the commercially available products including the polymerizable compound, MAXIVE manufactured by MITSUBISHI GAS CHEMICAL COMPANY, INC, NANOPOX 450, NANOPOX 500, and NANOPOX 630 manufactured by Evonik Industries, a series compounds such as COMPOCERAN 102 manufactured by Arakawa Chemical Industries, Ltd, FLEP and THIOKOL LP manufactured by Toray Fine Chemicals Co., Ltd, a series of compounds such as LOCTITE E-30CL manufactured by Henkel Japan Ltd, a series of compounds such as EPO-TEX353ND manufactured by Epoxy Technology Inc, and the like can be suitably exemplified.

If necessary, the composition forming the end face sealing layer 16 in the laminated film of the present invention may contain a polymerizable compound which does not contain a (meth)acryloyl group, a vinyl group, a glycidyl group, an oxetane group, and an alicyclic epoxy group.

Here, provided that the total amount of solid contents in the composition forming the end face sealing layer 16 is 100 parts by mass, the amount of the polymerizable compound, which does not contain the above functional groups, contained in the composition is preferably equal to or smaller than 3 parts by mass.

In the laminated film 10 of the present invention, particles of an inorganic substance (particles formed of an inorganic compound) may be dispersed in the end face sealing layer 16.

In a case where the end face sealing layer 16 contains the particles of an inorganic substance, the oxygen permeability of the end face sealing layer 16 can be further reduced, and the deterioration of the functional layer 12 resulting from oxygen or the like permeating from the end face can be more suitably prevented.

The size of the particles of an inorganic substance dispersed in the end face sealing layer 16 is not particularly limited, and may be appropriately set according to the thickness of the end face sealing layer 16 or the like. The size (maximum length) of the particles of an inorganic substance dispersed in the end face sealing layer 16 is preferably less than the thickness of the end face sealing layer 16. Particularly, the smaller the size of the particles, the more advantageous.

The size of the particles of an inorganic substance dispersed in the end face sealing layer 16 may be uniform or non-uniform.

The content of the particles of an inorganic substance in the end face sealing layer 16 may be appropriately set according to the size of the particles of an inorganic substance or the like.

According to the examination performed by the inventors of the present invention, the content of the particles of an inorganic substance in the end face sealing layer 16 is preferably equal to or smaller than 50% by mass, and more preferably 10% to 30% by mass. That is, provided that the total amount of solid contents in the composition forming the end face sealing layer 16 is 100 parts by mass, the content of the particles of an inorganic substance is preferably equal to or smaller than 50 parts by mass, and more preferably 10 to 30 parts by mass.

The greater the content of the particles of an inorganic substance is, the more the oxygen permeability of the end face sealing layer 16 is effectively reduced by the particles of an inorganic substance. In a case where the content of the particles of an inorganic substance is equal to or greater than 10% by mass, the effect obtained by the addition of the particles of an inorganic substance becomes more suitable, and an end face sealing layer 16 having a low oxygen permeability can be formed.

It is preferable that the content of the particles of an inorganic substance in the end face sealing layer 16 is equal to or smaller than 50% by mass, because then the adhesiveness or the durability of the end face sealing layer 16 can become sufficient, and the occurrence of cracking at the time of cutting or punching the laminated film can be inhibited.

Specific examples of the particles of an inorganic substance dispersed in the end face sealing layer 16 include inorganic layer-like minerals, silica particles, alumina particles, titania particles, silver particles, copper particles, and the like.

Next, the method for manufacturing a laminated film of the present invention will be described.

The method for manufacturing a laminated film of the present invention includes a preparation step of preparing a functional layer laminate having an optically functional layer and a gas barrier layer laminated on at least one main surface of the optically functional layer, and a sealing layer forming step of forming an end face sealing layer having an oxygen permeability of equal to or lower than 10 cc/(m²·day·atm) on an end face of the functional layer laminate, in which in the sealing layer forming step, the end face sealing layer is formed by bringing the end face of the functional layer laminate into contact with a coating film of a composition that becomes the end face sealing layer.

Hereinafter, an example of the method for manufacturing a laminated film of the present invention (hereinbelow, referred to as the manufacturing method of the present invention as well) will be described.

First, in the preparation step, the functional layer laminate 11 is prepared.

As the manufacturing method of the functional layer laminate 11, as described above, first, the organic layer 24 is formed on the surface of the support 20 by a coating method or the like, and the inorganic layer 26 is formed on the surface of the organic layer 24 by plasma CVD or the like. Then, the organic layer 28 is formed on the surface of the inorganic layer 26 by a coating method or the like, thereby preparing the gas barrier layer 14 (gas barrier film).

It is preferable that the formation of the organic layer and the inorganic layer is performed by a so-called roll-to-roll method. In the following description, “roll-to-roll” will be referred to as “RtoR” as well.

Meanwhile, a composition is prepared which contains an organic solvent, a compound forming a resin to be a matrix, quantum dots and the like and becomes the functional layer 12 such as a quantum dot layer.

Two sheets of gas barrier layers 14 are prepared, and the surface of the organic layer 28 of one of the gas barrier layers 14 is coated with the composition that becomes the functional layer 12. Furthermore, the other sheet of gas barrier layer 14 is laminated on the composition in a state where the organic layer 28 faces the composition side, and ultraviolet curing or the like is performed, thereby preparing a laminate in which the gas barrier layer 14 is laminated on both surfaces of the functional layer 12.

The prepared laminate is cut in a predetermined size, thereby preparing the functional layer laminate 11.

Then, in the sealing layer forming step, the aforementioned end face sealing layer 16 is formed on the end face of the functional layer laminate 11.

In the present invention, during the sealing layer forming step, the composition that becomes the end face sealing layer 16 is preferably formed into a coating film having a thickness which is equal to or smaller than ½ of the thickness T of the functional layer laminate 11, the end face of the functional layer laminate 11 is preferably brought into contact with the coating film having a thickness which is equal to or smaller than ½ of the thickness T of the functional layer laminate 11 such that the end face of the functional layer laminate 11 is coated with the composition, and the composition is preferably dried and cured such that the end face sealing layer 16 is formed.

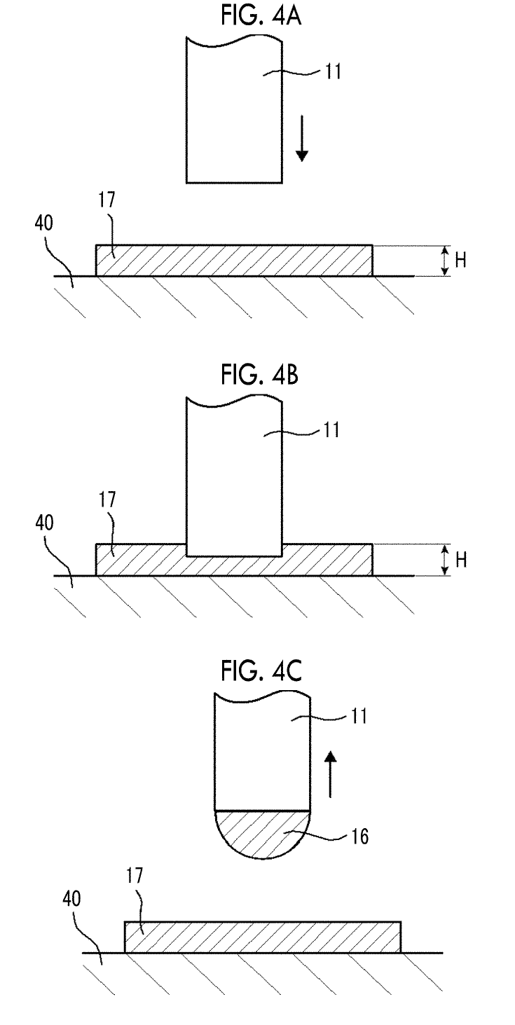

Hereinafter, an example of the sealing layer forming step will be described using FIGS. 4A to 4C.

First, as shown in FIG. 4A, a coating film 17 of the composition that becomes the end face sealing layer 16 is formed on a flat plate 40 (for example, a glass plate or a tray). A thickness H of the coating film 17 is equal to or smaller than ½ of the thickness T of the functional layer laminate 11. The size of the coating film 17 is not particularly limited as long as the coating film 17 can contact the entirety of the end face of a single functional layer laminate 11. For example, the length of one side of the coating film 17 may be greater than the length of the edge side of the functional layer laminate 11.

Then, as shown in FIG. 4B, the end face of the functional layer laminate 11 is brought into contact with the coating film 17 having the thickness H which is equal to or smaller than ½ of the thickness T of the functional layer laminate 11. Thereafter, as shown in FIG. 4C, the functional layer laminate 11 is lifted up in a vertical direction such that a predetermined amount of composition adheres to the end face of the functional layer laminate 11.

Because the thickness H of the coating film 17 is equal to or smaller than ½ of the thickness T of the functional layer laminate 11, the thickness of the composition, which adheres to the end face of the functional layer laminate 11 and becomes the end face sealing layer 16, is also equal to or smaller than ½ of the thickness T of the functional layer laminate 11.

Due to the surface tension of the composition, the composition having adhered to the end face of the functional layer laminate 11 has an approximately circular cross-sectional shape in a direction perpendicular to the extension direction of the end face.

After the composition is caused to adhere to the entirety of the end face of the functional layer laminate 11 as described above, the composition having adhered to the end face of the functional layer laminate 11 is dried and, if necessary, cured by ultraviolet irradiation, heating, and the like, thereby forming the end face sealing layer 16.

At the time of bringing the end face of the functional layer laminate 11 into contact with the coating film 17, only the end face of the functional layer laminate 11 may be brought into contact with the coating film 17. Alternatively, the edge of the functional layer laminate 11 may be immersed in the coating film 17 such that the end face and the coating film 17 contact each other.

In a case where the edge of functional layer laminate 11 is immersed in the coating film 17, the composition also adheres to the vicinity of the end face on the main surface of the functional layer laminate 11. However, due to the effect of surface tension, the composition wraps the end face side, and accordingly, the thickness of the end face sealing layer 16 (the thickness in a direction perpendicular to the main surface of the functional layer laminate 11) formed on the main surface of the functional layer laminate 11 does not increase.

In the example shown in FIG. 4C, a constitution is illustrated in which the end face of the functional layer laminate 11 is brought into contact with the coating film 17, and then the functional layer laminate 11 is moved up in the vertical direction such that the coating film 17 and the functional layer laminate 11 are separated from each other. However, the present invention is not limited thereto, and the coating film 17 (flat plate 40) may be moved down in the vertical direction, or the functional layer laminate 11 and the coating film 17 (flat plate 40) may be moved respectively.

In the example shown in FIG. 4B, a constitution is illustrated in which the end face of the functional layer laminate 11 is moved down in the vertical direction such that the end face contacts the coating film 17. However, the present invention is not limited thereto as long as the end face can be brought into contact with the coating film 17 having a predetermined thickness H.

The cross-sectional shape of the end face sealing layer 16 can be formed as a semicircular shape regardless of the magnitude of the absolute value of the surface energy (surface tension and contact angle) of the composition, as long as the end face of the functional layer laminate 11 is coated with the composition.

In the examples shown in FIGS. 4A to 4C, a constitution is illustrated in which the end face of a single sheet of functional layer laminate 11 is brought into contact with the coating film 17. However, the present invention is not limited thereto, and a constitution may be adopted in which a plurality of sheets of functional layer laminates 11 are collectively brought into contact with the coating film 17.

For example, functional layer laminates 11 and spacers may be alternately laminated such that the functional layer laminates 11 are separated from each other, and in this state, the end face thereof may be brought into contact with the coating film 17 of the composition forming the end face sealing layer 16 in the same manner as described above such that the end face sealing layer 16 is formed on the end face of each of the functional layer laminates 11.

Alternatively, as shown in FIG. 5A, on the entirety of the end face of a laminated material obtained by stacking a plurality of functional layer laminates 11 (for example, 1,000 sheets), an end face sealing layer 16A is formed in the same manner as described above, and then the stacked functional layer laminates 11 may be separated by one by one, thereby preparing the laminated film 10.

In a case where the end face sealing layer 16 is formed in the aforementioned manner, the end face sealing layer 16A formed on the end face of the laminated material obtained by stacking the functional layer laminates 11 has a semiovale shape. Therefore, the end face sealing layer 16 formed on the end face of the functional layer laminate 11 laminated in the vicinity of the center of the laminated material has an approximately rectangular shape as shown in FIG. 5B.

In the examples shown in FIGS. 4A to 4C, a constitution is illustrated in which during the sealing layer forming step, the coating film 17 of a composition is formed on a flat plate, and the end face of the functional layer laminate 11 is brought into contact with the coating film 17 such that the end face of the functional layer laminate 11 is coated with the composition that becomes the end face sealing layer 16. However, the present invention is not limited thereto.

For example, a constitution shown in FIG. 6 may be adopted in which the coating film of the composition is formed on a rotating roller, and the end face of the functional layer laminate is brought into contact with the coating film on the roller such that the end face sealing layer is formed.

The device shown in FIG. 6 has a tank 54 that stores the composition, a coating portion 52 that coats the peripheral surface of a roller 50 with the composition supplied from the tank 54, and the roller 50 that forms a coating film on the peripheral surface thereof. While the functional layer laminate 11 is being transported in a predetermined direction in synchronization with the rotating roller 50, the end face of the functional layer laminate 11 is brought into contact with the coating film on the roller 50 such that the composition adheres to the end face. Then, the composition is dried and, if necessary, cured by ultraviolet irradiation, heating, and the like, thereby forming the end face scaling layer 16.

In the manufacturing method of the present invention, in a case where the coating film is formed on the roller 50, and the end face sealing layer 16 is formed by bringing the end face of the functional layer laminate 11 into contact with the coating film on the roller 50, the thickness of the coating film formed on the roller 50 is made equal to or smaller than ½ of the thickness T of the functional layer laminate 11. In this way, on the end face of the functional layer laminate 11, the end face sealing layer 16 can be formed which has the thickness R of equal to or smaller than ½ of the thickness T of the functional layer laminate 11.

Hitherto, the laminated film and the method for manufacturing a laminated film of the present invention have been specifically described, but the present invention is not limited to the above examples. It goes without saying that the present invention may be ameliorated or modified in various ways within a scope that does not depart from the gist of the present invention.

### EXAMPLES

Hereinafter, the present invention will be more specifically described based on specific examples of the present invention. The present invention is not limited to the examples described below, and the materials, the amount and proportion of the materials used, the treatment content, the treatment sequence, and the like shown in the following examples can be appropriately modified as long as the modification does not depart from the gist of the present invention.

### Example 1

As Example 1, the laminated film 10 shown in FIG. 1 was prepared.

<Preparation of Gas Barrier Layer 14>

<<Support 20>>

As a support of the gas barrier layer 14, a polyethylene terephthalate film (PET film, manufactured by Toyobo Co., Ltd, trade name: COSMOSIIINE A4300, thickness: 50 μm, width: 1,000 mm, length: 100 m) was used.

<<Formation of Organic Layer 24>>

The organic layer 24 was formed on one surface of the support 20 as below.

First, a composition for forming the organic layer 24 was prepared. Specifically, trimethylolpropane triacrylate (TMPTA, manufactured by Daicel SciTech) and a photopolymerization initiator (manufactured by Lamberti S.p.A, FSACURE KTO46) were prepared, weighed such that a mass ratio of TMPTA:photopolymerization initiator became 95:5, and dissolved in methyl ethyl ketone, thereby preparing a composition with a concentration of solid contents of 15%.

By using the composition, the organic layer 24 was formed on one surface of the support 20 by a general film forming device which forms a film by a coating method using RtoR.

First, by using a die coater, one surface of the support 20 was coated with the composition. The support 20 having undergone coating was passed through a drying zone with a temperature of 50° C. for 3 minutes and then irradiated with ultraviolet rays (cumulative irradiation amount: about 600 mJ/cm²) such that the composition was cured, thereby forming the organic layer 24.

Furthermore, in the pass roll obtained immediately after the ultraviolet ray curing, as a protective film, a polyethylene film (PE film, manufactured by Sun A Kaken Co., Ltd., trade name: PAC 2-30-T) was bonded to the surface of the organic layer 24, and the resulting film was transported and wound up.

The thickness of the formed organic layer 24 was 1 μm.

<<Formation of Inorganic Layer 26>>

Then, by using a CVD device using RtoR, the inorganic layer 26 (silicon nitride (SiN) layer) was formed on the surface of the organic layer 24.

The support 20 on which the organic layer 24 was formed was fed from a feeding machine, and before an inorganic layer was formed, the protective film was peeled off after the laminate passed the last film surface-touching roll. Then, on the exposed organic layer 24, the inorganic layer 26 was formed by plasma CVD.

For forming the inorganic layer 26, as raw material gases, silane gas (flow rate: 160 sccm), ammonia gas (flow rate: 370 sccm), hydrogen gas (flow rate: 590 sccm), and nitrogen gas (flow rate: 240 sccm) were used. As a power source, a high-frequency power source having a frequency of 13.56 MHz was used. The film forming pressure was 40 Pa.

The thickness of the formed inorganic layer 26 was 50 nm.

The flow rate represented by the unit sccm is a value expressed in terms of a flow rate (cc/min) at 1,013 hPa and 0° C.

<<Formation of Organic Layer 28>>

Furthermore, the organic layer 28 was laminated on the surface of the inorganic layer 26 as below.

First, a composition for forming the organic layer 28 was prepared. Specifically, a urethane bond-containing acryl polymer (manufactured by TAISEI FINE CHEMICAL CO., LTD., ACRIT 8BR500, mass-average molecular weight: 250,000) and a photopolymerization initiator (IRGACURE 184 manufactured by BASF SE) were prepared, weighed such that a mass ratio of urethane bond-containing acryl polymer:photopolymerization initiator became 95:5, and dissolved in methyl ethyl ketone, thereby preparing a composition with a concentration of solid contents of 15% by mass.

By using the composition, the organic layer 28 was formed on the surface of the inorganic layer 26 by using a general film forming device that forms a film by a coating method using RtoR.

First, by using a die coater, one surface of the support 20 was coated with the composition. The support 20 having undergone coating was passed through a drying zone with a temperature of 100° C. for 3 minutes, thereby forming the organic layer 28.

In this way, the gas barrier layer 14 shown in FIG. 2 was prepared in which the organic layer 24, the inorganic layer 26, and the organic layer 28 were formed on the support 20. The thickness of the formed organic layer 24 was 1 μm.

In the pass roll obtained immediately after drying of the composition, as a protective film, a polyethylene film was bonded to the surface of the organic layer 28 in the same manner as described above, and then the gas barrier layer 14 was wound up.

<Preparation of Functional Layer Laminate>

A composition having the following makeup was prepared which was for forming a quantum dot layer as the functional layer 12.

(Makeup of Composition)

| | | |
|---|---|---|
| Toluene dispersion liquid of quantum dot 1 | 10 | parts by mass |
| (emission maximum: 520 nm) | | |
| Toluene dispersion liquid of quantum dot 2 | 1 | part by mass |
| (emission maximum: 630 nm) | | |
| Lauryl methacrylate | 2.4 | parts by mass |
| Trimethylolpropane triacrylate | 0.54 | parts by mass |
| Photopolymerization initiator (IRGACURE 819 | 0.009 | parts by mass |
| (manufactured by BASF SE)) | | |

As the quantum dots 1 and 2, the following nanocrystals having a core-shell structure (InP/ZnS) were used.

Quantum dot 1: INP 530-10 (manufactured by NN-LABS, LLC)

Quantum dot 2: INP 620-10 (manufactured by NN-LABS, LLC)

The viscosity of the prepared composition was 50 mPa·s.

By using the composition and a general film forming device that forms a film by a coating method using RtoR, the functional layer laminate 11 was prepared in which the gas barrier layer 14 was laminated on both surfaces of the functional layer 12.

Two sheets of gas barrier layers 14 were loaded on the film forming device at a predetermined position and transported. First, the protective film of one of the gas barrier layers was peeled, and then the surface of the organic layer 28 was coated with the composition by using a die coater. Thereafter, the protective film was peeled from the other gas barrier layer 14, and then the gas barrier layers 14 was laminated in a state where the organic layer 28 faced the composition.

Furthermore, the laminate in which the composition that becomes the functional layer 12 was sandwiched between the gas barrier layers 14 was irradiated with ultraviolet rays (cumulative irradiation amount: about 2,000 mJ/cm²), such that the composition was cured, and that the functional layer 12 was formed. In this way, the functional layer laminate 11 was prepared in which the gas barrier layer 14 was laminated on both surfaces of the functional layer 12.

The thickness of the functional layer 12 was 46 μm, and the thickness T of the functional layer laminate 11 was 150 μm.

By using a Thomson blade with a blade edge angle of 17°, the prepared functional layer laminate 11 was cut in the form of a sheet with A4 size.

<Formation of End Face Sealing Layer>

As a composition forming the end face sealing layer 16, a composition containing solid contents having the following makeup was prepared. Herein, the makeup is represented by part by mass that is determined in a case where the total solid content is regarded as being 100 parts by mass.

| | |
|---|---|
| Main agent of two liquid-type thermosetting epoxy | 40 parts by mass |
| resin (manufactured by Henkel Japan Ltd, E-30CL) | |
| Curing agent of two liquid-type thermosetting epoxy | 20 parts by mass |
| resin (manufactured by Henkel Japan Ltd, E-30CL) | |
| 1-Butanol | 40 parts by mass |

The flat plate 40 was coated with the prepared composition, thereby forming the coating film 17 having a thickness of 100 μm. Then, as shown in FIGS. 4A to 4C, the end face of the functional layer laminate 11 was brought into contact with the coating film 17 and then lifted up in a vertical direction, such that a predetermined amount of composition adhered to the end face. Thereafter, by drying and curing the composition for 10 minutes at 80° C., the end face sealing layer 16 was formed, and the laminated film 10 was prepared.

In the prepared laminated film 10, the end face sealing layer 16 covered a portion of the gas barrier layer 14 and the optically functional layer 12 within the entirety of the end face of the functional layer laminate 11.

The thickness R of the formed end face sealing layer 16 was 100 μm, and the end face sealing layer 16 had a rectangular cross-sectional shape.

Accordingly, a ratio between the thickness of the functional layer laminate 11 and the thickness of the end face sealing layer 16 was 0.66.

Furthermore, on a biaxially oriented polyester film (manufactured by TORAY INDUSTRIES, INC., LUMIRROR T60), a sample for measuring oxygen permeability having a thickness of 100 μm was prepared in the exactly same manner as used for preparing the end face sealing layer 16. Then, the sample for measuring oxygen permeability was peeled from the polyester film, and by using a measurement instrument (manufactured by NIPPON API CO., LTD.) adopting an APIMS method (atmospheric pressure ionization mass spectrometry), the oxygen permeability was measured under the condition of a temperature of 25° C. and a humidity of 60% RH.

As a result, the oxygen permeability of the sample for measuring oxygen permeability, that is, the end face sealing layer 16 was 10 cc/(m²·day·atm).

### Example 2

A laminated film was prepared in the same manner as in Example 1, except that as a composition forming the end face sealing layer 16, a composition with solid contents having the following makeup was prepared.

| | |
|---|---|
| Main agent of two liquid-type thermosetting epoxy | 14 parts by mass |
| resin (manufactured by MITSUBISHI GAS | |
| CHEMICAL COMPANY, INC., M-100) | |
| Curing agent of two liquid-type thermosetting epoxy | 46 parts by mass |
| resin (manufactured by MITSUBISHI GAS | |
| CHEMICAL COMPANY, INC., C-93) | |
| 1-Butanol | 40 parts by mass |

The oxygen permeability of the end face sealing layer 16 was measured in the same manner as in Example 1. As a result, the oxygen permeability was 0.4 cc/(m²·day·atm).

### Example 3

A laminated film was prepared in the same manner as in Example 1, except that the end face sealing layer 16 was constituted with two layers, a composition with solid contents having the following makeup was prepared as a composition forming the end face sealing layer 16, and the layers were sequentially laminated.

The first layer had a thickness of 95 μm, the second layer had 5 npm, and hence the total thickness was 100 μm.

<First Layer>

| | |
|---|---|
| Polyvinyl alcohol-based resin (manufactured | 20 parts by mass |
| by Nippon Synthetic Chemical Industry Co., | |
| Ltd., g polymer: OKS-8049) | |
| Pure water | 64 parts by mass |
| 2-Propanol | 16 parts by mass |

<Second Layer>

| | | |
|---|---|---|
| Main agent of two liquid-type thermosetting epoxy | 6 | parts by mass |
| resin (manufactured by MITSUBISHI GAS | | |
| CHEMICAL COMPANY, INC., M-100) | | |
| Curing agent of two liquid-type thermosetting epoxy | 19 | parts by mass |
| resin (manufactured by MITSUBISHI GAS | | |
| CHEMICAL COMPANY, INC., C-93) | | |
| 1-Butanol | 75 | parts by mass |

The oxygen permeability of the end face sealing layer 16 was measured in the same manner as in Example 1. As a result, the oxygen permeability was 0.1 cc/(m²·day·atm).

### Example 4

A laminated film was prepared in the same manner as in Example 3, except that the end face sealing layer 16 was constituted with three layers; and as compositions forming the end face sealing layer 16, the same composition as used for the second layer in Example 3 was used for the first layer, the same composition as used for the first layer in Example 3 was used for the second layer, and the same composition as used for the second layer in Example 3 was used for the third layer.

The first layer had a thickness of 5 μm, the second layer had a thickness of 95 μm, and the third layer had a thickness of 5 μm.

### Example 5

A laminated film was prepared in the same manner as in Example 2, except that the end face sealing layer 16 had a thickness of 75 μm.

That is, a ratio between the thickness of the functional layer laminate 11 and the thickness of the end face sealing layer 16 was 0.5.

The oxygen permeability of the end face sealing layer 16 was measured in the same manner as in Example 1. As a result, the oxygen permeability was 0.6 cc/(m²·day·atm).

### Example 6

A laminated film was prepared in the same manner as in Example 2, except that a constitution was adopted in which the end face sealing layer 16 covered the gas barrier layer 14 and the optically functional layer 12 in the entire region of the end face of the functional layer laminate 11.

The oxygen permeability of the end face sealing layer 16 was measured in the same manner as in Example 1. As a result, the oxygen permeability was 0.4 cc/(m²·day·atm).

### Example 7

A laminated film was prepared in the same manner as in Example 5, except that the end face sealing layer 16 had an arc-like cross-sectional shape.

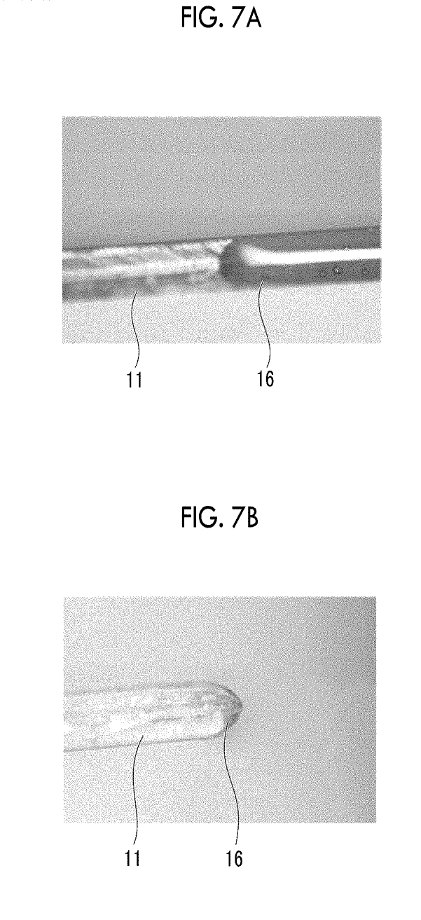

FIG. 7A is an optical micrograph which is a front view of the end face of the functional layer laminate 11 in which the end face sealing layer 16 of Example 7 was formed. FIG. 7B is an optical micrograph showing a cross-section of the end face sealing layer 16. As is evident from FIG. 7B, the end face sealing layer 16 is formed on the end face without wrapping the main surface side of the functional layer laminate 11.

### Example 8

A laminated film was prepared in the same manner as in Example 1, except that the end face sealing layer 16 was constituted with two layers, a composition with solid contents having the following makeup was prepared as a composition forming the end face sealing layer 16, and the layers were sequentially laminated.

The first layer had a thickness of 70 μm, the second layer had a thickness of 5 μm, and hence the total thickness was 75 μm.

<First Layer>

| | | |
|---|---|---|
| Polyvinyl alcohol-based resin (manufactured | 16 | parts by mass |
| by Nippon Synthetic Chemical Industry Co., | | |
| Ltd., g polymer: OKS-8049) | | |
| Inorganic layered compound (manufactured | 4 | parts by mass |
| by CO-OP CHEMICAL CO., LTD., | | |
| SOMASIF ME100) | | |
| Pure water | 64 | parts by mass |
| 2-Propanol | 16 | parts by mass |

<Second Layer>

| | | |
|---|---|---|
| Main agent of two liquid-type thermosetting epoxy | 6 | parts by mass |
| resin (manufactured by MITSUBISHI GAS | | |
| CHEMICAL COMPANY, INC., M-100) | | |
| Curing agent of two liquid-type thermosetting epoxy | 19 | parts by mass |
| resin (manufactured by MITSUBISHI GAS | | |
| CHEMICAL COMPANY, INC., C-93) | | |
| 1-Butanol | 75 | parts by mass |

The oxygen permeability of the end face sealing layer 16 was measured in the same manner as in Example 1. As a result, the oxygen permeability was 0.05 cc/(m²·day·atm).

### Example 9

A laminated film was prepared in the same manner as in Example 5, except that a composition with solid contents having the following makeup was prepared as a composition forming the end face sealing layer 16.

| | | |
|---|---|---|
| Polyvinyl alcohol-based resin (manufactured | 16 | parts by mass |
| by The Nippon Synthetic Chemical Industry Co., | | |
| Ltd., g polymer: OKS-8049) | | |
| Hydrolysate of tetraethyl orthosilicate | 4 | parts by mass |
| Pure water | 64 | parts by mass |
| 2-Propanol | 16 | parts by mass |

The aforementioned hydrolysate of tetraethyl orthosilicate was prepared by stirring a composition having the following makeup for 5 hours.

| | | |
|---|---|---|
| Tetraethyl orthosilicate (manufactured | 6 | parts by mass |
| by TOKYO CHEMICAL INDUSTRY | | |
| CO., LTD.) | | |
| Acetic anhydride | 0.05 | parts by mass |
| Pure water | 2.3 | parts by mass |
| Ethanol | 6.6 | parts by mass |

### Comparative Example 1

A laminated film was prepared in the same manner as in Example 1, except that the end face sealing layer 16 was not formed.

### Comparative Example 2

A laminated film was prepared in the same manner as in Example 1, except that a composition with solid contents having the following makeup was prepared as a composition forming the end face sealing layer, and the composition was cured not by the drying at 80° C. for 10 minutes but by the irradiation of ultraviolet rays (cumulative irradiation amount: about 800 mJ/cm²).

| | | |
|---|---|---|
| Trifunctional acrylate monomer (manufactured | 100 | parts by mass |
| by Daicel SciTech, TMPTA) | | |
| Methyl ethyl ketone | 60 | parts by mass |
| Photopolymerization initiator (manufactured | 3 | parts by mass |
| by BASF SE, IRGACURE 819) | | |

The oxygen permeability of the end face sealing layer was measured in the same manner as in Example 1. As a result, the oxygen permeability was 20 cc/(m²·day·atm).

Furthermore, in the laminated film prepared in Comparative Example 2, a portion of the optically functional layer of the functional layer laminate was not covered with the end face sealing layer.

[Evaluation]

The laminated films of Examples 1 to 8 and Comparative Examples 1 and 2 prepared as above were evaluated in terms of the performance deterioration (barrier properties) of the edge and the film flatness.

<Barrier Properties>

By measuring the degree of performance deterioration of the edge, the barrier properties of the end face sealing layer were evaluated.

First, an initial luminance (Y0) of the laminated film was measured in the following sequence. A commercially available tablet terminal (Kindle (registered trademark) Fire HDX 7″ manufactured by Amazon.com, Inc) was disassembled, and the backlight unit was taken out. The laminated film was disposed on the light guide plate of the backlight unit taken out, and two prism sheets of directions orthogonal to each other were stacked on the laminated film. The luminance of light, which was emitted from a blue light source and transmitted through the laminated film and two prism sheets, was measured using a luminance meter (SR3, manufactured by TOPCON CORPORATION) installed in a position 740 mm distant from light guide plate in a direction perpendicular to the surface of the light guide plate, and taken as the luminance of the laminated film.

Then, the laminated film was put into a constant-temperature tank kept at 60° C. and a relative humidity of 90% and stored as it was for 1,000 hours. After 1,000 hours, the laminated film was taken out, and a luminance (Y1) after the high-temperature high-humidity testing was measured in the same sequence as described above. By using the following equation, a rate of change (ΔY) of the luminance (Y1) after the high-temperature high-humidity testing with respect to the initial luminance (Y0) was calculated. By using ΔY as a parameter of a luminance change, the barrier properties were evaluated based on the following standards.

ΔY[%]=(Y0−Y1)/Y0×100

A: ΔY≤5%

B: 5%<ΔY<15%

C: 15%≤ΔY

<Flatness>

The thickness T of the functional layer laminate 11 and the width D (see FIG. 3B) of the end face sealing layer 16 were measured. Based on a ratio between the thickness T of the functional layer laminate 11 and the width D of the end face sealing layer 16, the flatness was evaluated as below.

A: D≤1.2 T

B: 1.2 T<D≤1.4 T

C: 1.4 T<D

The results are shown in Table 1.

TABLE 1

| | End face sealing layer | | | | | |
|---|---|---|---|---|---|---|
| | | | Thickness of end face | | Evaluation | |
| | Oxygen permeability | Number | sealing layer/thickness of | Cross-sectional | Barrier | |
| Test No. | cc/(m² · day · atm) | of layers | functional layer laminate | shape | properties | Flatness |
| Example 1 | 10 | 1 | 0.66 | Rectangular | B | B |
| Example 2 | 0.4 | 1 | 0.66 | Rectangular | A | B |
| Example 3 | 0.1 | 2 | 0.66 | Rectangular | A | B |
| Example 4 | 0.1 | 3 | 0.66 | Rectangular | A | B |
| Example 5 | 0.6 | 1 | 0.5 | Rectangular | A | A |
| Example 6 | 0.4 | 1 | 0.66 | Rectangular | A | A |
| Example 7 | 0.6 | 1 | 0.5 | Arc-like | A | A |
| Example 8 | 0.07 | 2 | 0.5 | Rectangular | A | A |
| Example 9 | 0.05 | 1 | 0.5 | Rectangular | A | A |
| Comparative | — | — | — | Rectangular | C | A |
| Example 1 | | | | | | |
| Comparative | 20 | 1 | 0.66 | Rectangular | C | B |
| Example 2 | | | | | | |

As shown in Table 1, it is understood that the non-light-emitting region on the edge is further reduced in the laminated film of the present invention than in Comparative Examples 1 and 2, and the deterioration of quantum dots (optically functional layer) can be prevented in the laminated film of the present invention because oxygen and water are blocked by the end face sealing layer.

From the comparison between Example 2 and Example 4, the comparison between Example 3 and Example 8, and the like, it is understood that in a case where the thickness R of the end face sealing layer is equal to or smaller than ½ of the thickness of the functional layer laminate, the flatness can be improved.

These results clearly show the effects of the present invention.

### EXPLANATION OF REFERENCES

10: laminated film
12: optically functional layer
14: gas barrier film
16, 16A: end face sealing layer
20: support
24, 28: organic layer
26: inorganic layer
40: flat plate
50: roller
52: coating portion
54: tank

What is claimed is:

1. A laminated film comprising:
a functional layer laminate having an optically functional layer and a gas barrier layer laminated on at least one main surface of the optically functional layer, and
an end face sealing layer formed by covering at least a portion of the gas barrier layer and the optically functional layer of an end face of the functional layer laminate,
wherein the end face sealing layer has an oxygen permeability of equal to or lower than 10 cc/(m²·day·atm).

2. The laminated film according to claim 1,
wherein the end face sealing layer has a laminated structure in which two or more layers are laminated.

3. The laminated film according to claim 1,
wherein a thickness of the end face sealing layer in a direction perpendicular to the end face of the functional layer laminate is equal to or smaller than ½ of a thickness of the functional layer laminate in a direction perpendicular to a main surface of the functional layer laminate.

4. The laminated film according to claim 2,
wherein a thickness of the end face sealing layer in a direction perpendicular to the end face of the functional layer laminate is equal to or smaller than ½ of a thickness of the functional layer laminate in a direction perpendicular to a main surface of the functional layer laminate.

5. The laminated film according to claim 1,
wherein the end face sealing layer covers the entirety of the end face of the functional layer laminate.

6. The laminated film according to claim 4,
wherein the end face sealing layer covers the entirety of the end face of the functional layer laminate.

7. The laminated film according to claim 1,
wherein the end face sealing layer is a resin layer formed of a composition and having an oxygen permeability of equal to or smaller than 10 cc/(m²·day·atm), and
provided that a total amount of solid contents in the composition is 100 parts by mass, the composition contains either a resin composition selected from the group consisting of a polyvinyl alcohol-based resin, a polyvinylidene chloride resin, polyacrylonitrile, a polyvinylidene fluoride resin, and polyoxymethylene or a polymerizable compound having at least one polymerizable functional group selected from a (meth)acryloyl group, a vinyl group, a glycidyl group, an oxetane group, and an alicyclic epoxy group in an amount of equal to or greater than 5 parts by mass.

8. The laminated film according to claim 6,
wherein the end face sealing layer is a resin layer formed of a composition and having an oxygen permeability of equal to or smaller than 10 cc/(m²·day·atm), and
provided that a total amount of solid contents in the composition is 100 parts by mass, the composition contains either a resin composition selected from the group consisting of a polyvinyl alcohol-based resin, a polyvinylidene chloride resin, polyacrylonitrile, a polyvinylidene fluoride resin, and polyoxymethylene or a polymerizable compound having at least one polymerizable functional group selected from a (meth)acryloyl group, a vinyl group, a glycidyl group, an oxetane group, and an alicyclic epoxy group in an amount of equal to or greater than 5 parts by mass.

9. The laminated film according to claim 1,
wherein in a cross-section perpendicular to an extension direction of the end face of the functional layer laminate, the end face sealing layer has a shape formed of a portion of a circle.

10. The laminated film according to claim 8,
wherein in a cross-section perpendicular to an extension direction of the end face of the functional layer laminate, the end face sealing layer has a shape formed of a portion of a circle.
